(19) United States
(12) Patent Application Publication
(10) Pub. No.: US 2026/0252051 A1
(43) Pub. Date: Aug. 27, 2026

(54) FAULT TREE DIAGRAM UPDATING SYSTEM

(71) Applicant: HITACHI, Ltd., Tokyo (JP)

(72) Inventors: Tsubasa WATANABE, Spring Lake, MI (US); Lasitha VIDYARATNE, Fremont, CA (US)

(21) Appl. No.: 19/065,965

(22) Filed: Feb. 27, 2025

(51) Int. Cl. G05B 19/406

(52) U.S. Cl. CPC G05B 19/406; G05B 2219/34477

(57) ABSTRACT

A fault tree generation and update method, the method comprising: calculating, by a processor, similarity between a plurality of past maintenance reports; classifying, by the processor, the plurality of past maintenance reports based on the similarity; selecting, by the processor, a subset of the plurality of past maintenance reports associated with a classification as input to an Artificial Intelligence (AI) model; providing, by the processor, a fault tree generation instruction to the AI model for generating a fault tree using the subset of the plurality of past maintenance reports; and receiving, by the processor, the fault tree as output from the AI model.

### BACKGROUND

### Field

The present disclosure is generally directed to methods and systems for generating and updating fault tree.

### Related Art

Maintaining production line uptime is essential in maximizing productivity in a factory/production setting. A key factor that reduces production line uptime is machine abnormality, which prompts recovery actions to be taken based on a root cause analysis of machine fault. A Fault Tree Analysis (FTA) is commonly performed using a fault tree to identify potential causes of system failure/machine abnormality. The fault tree is a tree diagram containing a top node indicating fault phenomena, a lower node indicating fault cause, and a branch indicating causality of phenomena or a recovery method. The fault tree is an effective tool as it can be used to immediately identify fault cause based on description of the fault phenomenon as contained in the fault tree, which helps eliminate prolonged downtime.

Fault trees are generally created based on design information used to construct the production line. Ideally, a fault tree should be updated by adding fault phenomenon newly identified during operation of the production line. However, this is not often performed as it takes time to check and process maintenance reports, which contain information on the fault phenomenon that occurred. The maintenance reports would then be compared against existing fault trees to determine whether updates are needed.

In the related art, a method for updating fault trees through information extraction is disclosed. The method performs fault tree updates by extracting fault phenomena, fault causes, and recovery methods from past maintenance reports and integrating fault trees if similarity between a new fault tree and an existing fault tree is equal to or greater than a predetermined level/threshold.

However, maintenance reports tend to contain cognitive biases of the creator, especially in items such as fault phenomena and fault causes. Recovery methods on the other hand is fact-based and prone to missing items, typos, and expression variations. If all fault tree items are generated with a single generation setting, this will likely result in fault tree duplication and decreased generation accuracy.

There exists a need for a method and a system that can automatically update fault trees based on past maintenance reports to reduce expression errors and expression variations.

### SUMMARY

Aspects of the present disclosure involve an innovative method for generating and updating fault tree. The method may include calculating, by a processor, similarity between a plurality of past maintenance reports; classifying, by the processor, the plurality of past maintenance reports based on the similarity; selecting, by the processor, a subset of the plurality of past maintenance reports associated with a classification as input to an Artificial Intelligence (AI) model; providing, by the processor, a fault tree generation instruction to the AI model for generating a fault tree using the subset of the plurality of past maintenance reports; and receiving, by the processor, the fault tree as output from the AI model.

In some example implementations, the AI model may be a large language model.

In some example implementations, the method may further include adding, by the processor, the fault tree to a fault tree diagram that contains an existing fault tree; and updating, by the processor, the existing fault tree with the fault tree by calculating similarities between the fault tree and the existing fault tree.

The processor may be configured to update the existing fault tree by: calculating a fault phenomenon similarity between a fault phenomenon of the fault tree and the existing fault tree; for the fault phenomenon similarity being determined to satisfy a first threshold, integrating the fault phenomenon into the existing fault tree, and calculating a fault cause similarity between a fault cause of the fault tree and the existing fault tree, the fault cause is associated with the fault phenomenon; for the fault cause similarity being determined to satisfy a second threshold, integrating the fault cause into the existing fault tree, and calculating a recovery method similarity between a recovery method of the fault tree and the existing fault tree, the recovery method is associated with the fault cause; and for the recovery method similarity being determined to satisfy a third threshold, integrating the recovery method into the existing fault tree.

In some example implementations, the fault tree generation instruction may include one or more of a fault phenomenon generation setting instruction, a fault cause generation setting instruction, or a recovery method generation setting instruction.

In some example implementations, the fault phenomenon generation setting instruction may include a temperature setting for generating a fault phenomenon.

In some example implementations, the fault cause generation setting instruction may include a temperature setting for generating a fault cause.

In some example implementations, the recovery method generation setting instruction may include a temperature setting for generating a recovery method.

In some example implementations, selecting the subset of the plurality of past maintenance reports may include: retrieving, by the processor, a first set of past maintenance reports associated with the classification, the first set of past maintenance reports comprises all past maintenance reports that are associated with the classification; determining, by the processor for each of the first set of past maintenance reports, (i) whether a report reference frequency satisfies a reference threshold; and (ii) whether skill level of a report creator satisfies a skill threshold; for the reference threshold or the skill threshold being determined as satisfied for one or more of the first set of past maintenance reports, setting, by the processor, the one or more of the first set of past maintenance reports as the subset of the plurality of past maintenance reports; and for the reference threshold and the skill threshold being determined as not satisfied for all of the first set of past maintenance reports, setting, by the processor, the first set of past maintenance reports as the subset of the plurality of past maintenance reports.

In some example implementations, the method may further include: for the reference threshold or the skill threshold being determined as satisfied for the one or more of the first set of past maintenance reports, setting, by the processor, the temperature setting for generating the fault phenomenon, the temperature setting for generating the fault cause, and the temperature setting for generating the recovery method to a first temperature level; and for the reference threshold and the skill threshold being determined as not satisfied for all of the first set of past maintenance reports, setting, by the processor, the temperature setting for generating the fault phenomenon, the temperature setting for generating the fault cause, and the temperature setting for generating the recovery method to a second temperature level, wherein the first temperature level is lower than the second temperature level.

In some example implementations, the method may further include: adding, by the processor, the fault tree to a fault tree diagram that contains an existing fault tree; outputting, by the processor, the fault tree diagram to a user for evaluation; receiving, by the processor, an evaluation score of the fault tree diagram from the user; comparing, by the processor, the evaluation score against an evaluation threshold; for the evaluation score being determined to satisfy the evaluation threshold, setting, by the processor, the fault tree generation instruction as default instruction; and for the evaluation score being determined to not satisfy the evaluation threshold, modifying, by the processor, the fault tree generation instruction and reperforming fault tree generation.

In some example implementations, the method may further include: providing, by the processor, an existing fault tree to the AI model; wherein the AI model generates the fault tree by referring to the existing fault tree to generate items in the fault tree.

In some example implementations, the items may include a fault phenomenon, a fault cause, and a recovery method.

In some example implementations, the fault tree generation instruction may include a first reference degree, a second reference degree, and a third reference degree for referencing the existing fault tree in generating the fault phenomenon, the fault cause, and the recovery method respectively; wherein the third reference degree, the second reference degree, and the first reference degree are in an ascending order.

Aspects of the present disclosure involve an innovative system for generating and updating fault tree. The system may include a data storage and a processor in communication with the data storage, wherein the processor is configured to: calculate similarity between a plurality of past maintenance reports stored in the data storage; classify the plurality of past maintenance reports based on the similarity; select a subset of the plurality of past maintenance reports associated with a classification as input to an Artificial Intelligence (AI) model; provide a fault tree generation instruction to the AI model for generating a fault tree using the subset of the plurality of past maintenance reports; and receive the fault tree as output from the AI model and storing the fault tree in the data storage.

In some example implementations, the processor is further configured to: add the fault tree to a fault tree diagram that contains an existing fault tree; and update the existing fault tree with the fault tree by calculating similarities between the fault tree and the existing fault tree.

In some example implementations, the processor is configured to update the existing fault tree by: calculating a fault phenomenon similarity between a fault phenomenon of the fault tree and the existing fault tree; for the fault phenomenon similarity being determined to satisfy a first threshold, integrating the fault phenomenon into the existing fault tree, and calculating a fault cause similarity between a fault cause of the fault tree and the existing fault tree, the fault cause is associated with the fault phenomenon; for the fault cause similarity being determined to satisfy a second threshold, integrating the fault cause into the existing fault tree, and calculating a recovery method similarity between a recovery method of the fault tree and the existing fault tree, the recovery method is associated with the fault cause; and for the recovery method similarity being determined to satisfy a third threshold, integrating the recovery method into the existing fault tree.

In some example implementations, the fault tree generation instruction may include one or more of a fault phenomenon generation setting instruction, a fault cause generation setting instruction, or a recovery method generation setting instruction.

In some example implementations, the fault phenomenon generation setting instruction may include a temperature setting for generating a fault phenomenon.

In some example implementations, the fault cause generation setting instruction may include a temperature setting for generating a fault cause.

In some example implementations, the recovery method generation setting instruction may include a temperature setting for generating a recovery method.

In some example implementations, the processor is configured to select the subset of the plurality of past maintenance reports by: retrieving a first set of past maintenance reports associated with the classification, the first set of past maintenance reports comprises all past maintenance reports that are associated with the classification; determining, for each of the first set of past maintenance reports, (i) whether a report reference frequency satisfies a reference threshold; and (ii) whether skill level of a report creator satisfies a skill threshold; for the reference threshold or the skill threshold being determined as satisfied for one or more of the first set of past maintenance reports, setting the one or more of the first set of past maintenance reports as the subset of the plurality of past maintenance reports; and for the reference threshold and the skill threshold being determined as not satisfied for all of the first set of past maintenance reports, setting the first set of past maintenance reports as the subset of the plurality of past maintenance reports.

In some example implementations, the processor is further configured to: for the reference threshold or the skill threshold being determined as satisfied for the one or more of the first set of past maintenance reports, set the temperature setting for generating the fault phenomenon, the temperature setting for generating the fault cause, and the temperature setting for generating the recovery method to a first temperature level; and for the reference threshold and the skill threshold being determined as not satisfied for all of the first set of past maintenance reports, set the temperature setting for generating the fault phenomenon, the temperature setting for generating the fault cause, and the temperature setting for generating the recovery method to a second temperature level, wherein the first temperature level is lower than the second temperature level.

In some example implementations, the processor is further configured to: add the fault tree to a fault tree diagram that contains an existing fault tree; output the fault tree diagram to a user for evaluation; receive an evaluation score of the fault tree diagram from the user; compare the evaluation score against an evaluation threshold; for the evaluation score being determined to satisfy the evaluation threshold, set the fault tree generation instruction as default instruction; and for the evaluation score being determined to not satisfy the evaluation threshold, modify the fault tree generation instruction and reperforming fault tree generation.

In some example implementations, the processor is further configured to: provide an existing fault tree to the AI model, wherein the AI model generates the fault tree by referring to the existing fault tree to generate items in the fault tree, wherein the items comprise a fault phenomenon, a fault cause, and a recovery method, wherein the fault tree generation instruction comprises a first reference degree, a second reference degree, and a third reference degree for referencing the existing fault tree in generating the fault phenomenon, the fault cause, and the recovery method respectively, wherein the third reference degree, the second reference degree, and the first reference degree are in an ascending order.

Aspects of the present disclosure involve an innovative non-transitory computer readable medium, storing instructions for generating and updating fault tree. The instructions may include calculating similarity between a plurality of past maintenance reports stored in the data storage; classifying the plurality of past maintenance reports based on the similarity; selecting a subset of the plurality of past maintenance reports associated with a classification as input to an Artificial Intelligence (AI) model; providing a fault tree generation instruction to the AI model for generating a fault tree using the subset of the plurality of past maintenance reports; and receiving the fault tree as output from the AI model and storing the fault tree in the data storage.

In some example implementations, the instructions may further include adding the fault tree to a fault tree diagram that contains an existing fault tree and updating the existing fault tree with the fault tree by calculating similarities between the fault tree and the existing fault tree.

In some example implementations, updating the existing fault tree may include: calculating a fault phenomenon similarity between a fault phenomenon of the fault tree and the existing fault tree; for the fault phenomenon similarity being determined to satisfy a first threshold, integrating the fault phenomenon into the existing fault tree, and calculating a fault cause similarity between a fault cause of the fault tree and the existing fault tree, the fault cause is associated with the fault phenomenon; for the fault cause similarity being determined to satisfy a second threshold, integrating the fault cause into the existing fault tree, and calculating a recovery method similarity between a recovery method of the fault tree and the existing fault tree, the recovery method is associated with the fault cause; and for the recovery method similarity being determined to satisfy a third threshold, integrating the recovery method into the existing fault tree.

In some example implementations, the fault tree generation instruction may include one or more of a fault phenomenon generation setting instruction, a fault cause generation setting instruction, or a recovery method generation setting instruction.

In some example implementations, the fault phenomenon generation setting instruction may include a temperature setting for generating a fault phenomenon.

In some example implementations, the fault cause generation setting instruction may include a temperature setting for generating a fault cause.

In some example implementations, the recovery method generation setting instruction may include a temperature setting for generating a recovery method.

In some example implementations, selecting the subset of the plurality of past maintenance reports may include: retrieving a first set of past maintenance reports associated with the classification, the first set of past maintenance reports comprises all past maintenance reports that are associated with the classification; determining, for each of the first set of past maintenance reports, (i) whether a report reference frequency satisfies a reference threshold; and (ii) whether skill level of a report creator satisfies a skill threshold; for the reference threshold or the skill threshold being determined as satisfied for one or more of the first set of past maintenance reports, setting the one or more of the first set of past maintenance reports as the subset of the plurality of past maintenance reports; and for the reference threshold and the skill threshold being determined as not satisfied for all of the first set of past maintenance reports, setting the first set of past maintenance reports as the subset of the plurality of past maintenance reports.

In some example implementations, the instructions may further include: for the reference threshold or the skill threshold being determined as satisfied for the one or more of the first set of past maintenance reports, setting the temperature setting for generating the fault phenomenon, the temperature setting for generating the fault cause, and the temperature setting for generating the recovery method to a first temperature level; and for the reference threshold and the skill threshold being determined as not satisfied for all of the first set of past maintenance reports, setting the temperature setting for generating the fault phenomenon, the temperature setting for generating the fault cause, and the temperature setting for generating the recovery method to a second temperature level, wherein the first temperature level is lower than the second temperature level.

In some example implementations, the instructions may further include: adding the fault tree to a fault tree diagram that contains an existing fault tree; outputting the fault tree diagram to a user for evaluation; receiving an evaluation score of the fault tree diagram from the user; comparing the evaluation score against an evaluation threshold; for the evaluation score being determined to satisfy the evaluation threshold, setting the fault tree generation instruction as default instruction; and for the evaluation score being determined to not satisfy the evaluation threshold, modifying the fault tree generation instruction and reperforming fault tree generation.

In some example implementations, the instructions may further include: providing an existing fault tree to the AI model, wherein the AI model generates the fault tree by referring to the existing fault tree to generate items in the fault tree, wherein the items comprise a fault phenomenon, a fault cause, and a recovery method, wherein the fault tree generation instruction comprises a first reference degree, a second reference degree, and a third reference degree for referencing the existing fault tree in generating the fault phenomenon, the fault cause, and the recovery method respectively, wherein the third reference degree, the second reference degree, and the first reference degree are in an ascending order.

### BRIEF DESCRIPTION OF DRAWINGS

A general architecture that implements the various features of the disclosure will now be described with reference to the drawings. The drawings and the associated descriptions are provided to illustrate example implementations of the disclosure and not to limit the scope of the disclosure. Throughout the drawings, reference numbers are reused to indicate correspondence between referenced elements.

FIG. 1 illustrates a conventional fault tree diagram 100.

FIGS. 2A-2C illustrate example maintenance reports that are used in generating fault trees.

FIG. 3A illustrates a fault tree 300 generated using a maintenance report that contains an expression error.

FIG. 3B illustrates an existing fault tree diagram 350 that has been updated with the newly generated fault tree of FIG. 3A.

FIG. 4 illustrates an example fault tree diagram updating system 400, in accordance with an example implementation.

FIG. 5 illustrates an example process flow 500 for updating an existing fault tree using the fault tree diagram updating system 400, in accordance with an example implementation.

FIG. 6 illustrates an example fault tree generation instruction 600, in accordance with an example implementation.

FIG. 7 illustrates an alternate fault tree diagram updating system 700, in accordance with an example implementation.

FIG. 8 illustrates an alternate process flow 800 for updating an existing fault tree using the fault tree diagram updating system 700, in accordance with an example implementation.

FIG. 9 illustrates an example generation setting instruction 900, in accordance with an example implementation.

FIG. 10 illustrates an alternate fault tree diagram updating system 1000, in accordance with an example implementation.

FIG. 11 illustrates an alternate process flow 1100 for updating an existing fault tree using the fault tree diagram updating system 1000, in accordance with an example implementation.

FIG. 12 illustrates an example generative directive 1200, in accordance with an example implementation.

FIG. 13 illustrates an alternate process flow 1300 for updating an existing fault tree, in accordance with an example implementation.

FIG. 14 illustrates an example process flow 1400 for performing step S1302 of FIG. 13, in accordance with an example implementation.

FIG. 15 illustrates an alternate fault tree diagram updating system 1500, in accordance with an example implementation.

FIG. 16 illustrates an alternate process flow 1600 for updating an existing fault tree using the fault tree diagram updating system 1500, in accordance with an example implementation.

FIG. 17 illustrates an example computing environment 1700 with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of the ordinary skills in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

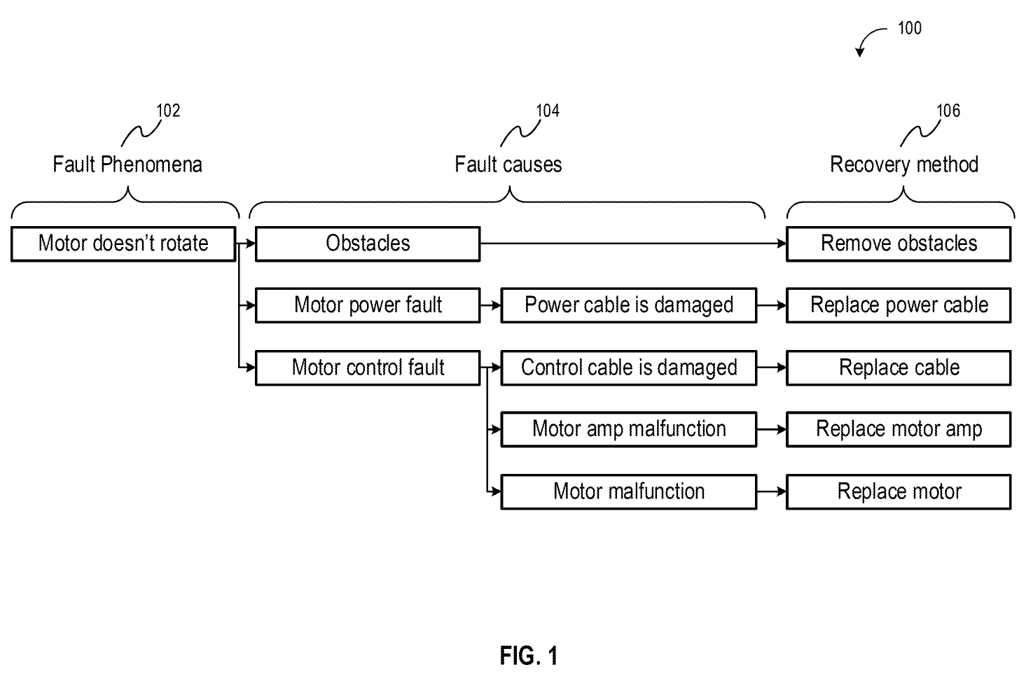

FIG. 1 illustrates a conventional fault tree diagram 100. As shown in FIG. 1, the fault tree diagram 100 contains a top node 102 indicating fault phenomena, lower nodes 104 indicating fault causes, and branches 106 indicating known recovery methods. For example, the fault phenomena of “motor doesn’t rotate” has “obstacles” as a fault cause, which has a known recovery method of “remove obstacles.”

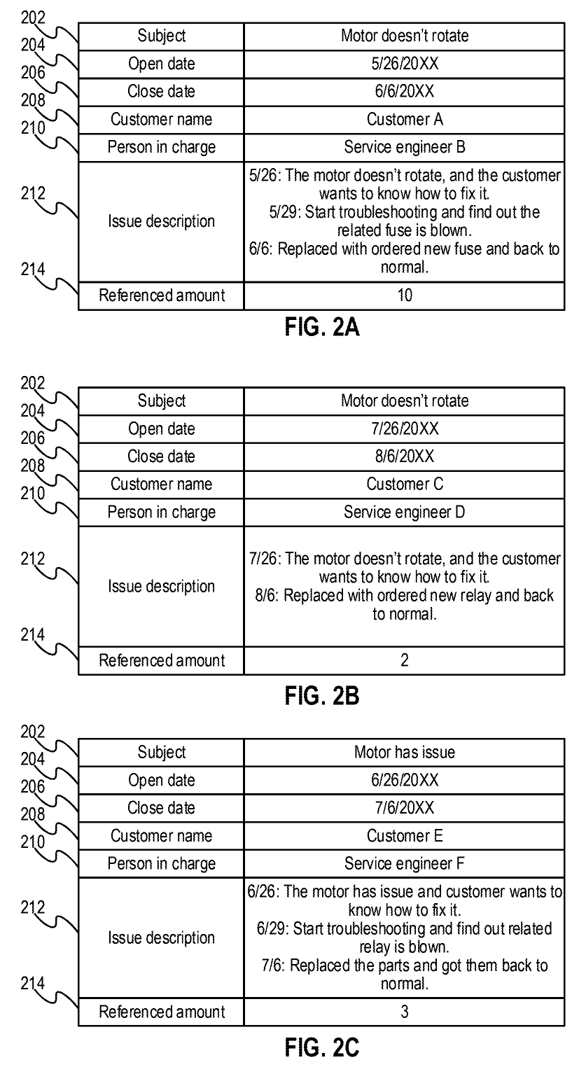

FIGS. 2A-2C illustrate example maintenance reports that are used in generating fault trees. Maintenance reports contain background information on maintenance support/activities performed on equipment, facilities, or systems. As illustrated in FIGS. 2A-2C, a maintenance report may include report components such as, but not limited to, a subject 202, an open date 204, a close date 206, customer name 208, person in charge 210, issue description 212, reference count 214, etc. Subject 202 contains a topic/theme of the report. The open date 204 indicates when the maintenance report was opened. The close date 206 indicates when the maintenance report was closed. Each maintenance report can be used to derive a fault tree.

The customer name 208 indicates customer who is associated with the component that is experiencing the abnormality/fault. Person in charge 210 provides information as to who is currently serving the customer to address the abnormality/fault. The individual identified in person in charge 210 may be the same person who is generating the maintenance report. Using FIG. 2A as example, “Customer A” is in possession of the motor that is not rotating. Issue description 212 contains a brief summary that describes the abnormality/fault encountered, and is typically in the form of a single paragraph. The reference amount 214 corresponds to the number of times the maintenance is accessed for maintenance support after it has been closed.

FIG. 2B illustrates a maintenance report that lacks sufficient issue description (e.g., steps taken to address the issues). The insufficiency may be due to the service engineer’s (person in charge 210) skill level or experience level. FIG. 2C illustrates a maintenance report that lacks detailed fault/abnormality description. This may be due to customer’s or service engineer’s misdiagnosis of the issues.

In the conventional approach, if the necessary information exists in a maintenance report (e.g., FIG. 2A), a fault tree can be created without any problems. However, if a maintenance report lacks sufficient information/description, contains expression errors, contains expression variations, etc. (as shown in FIGS. 2B and 2C), this then leads to the creation of an inaccurate fault tree. When merged with an existing fault tree diagram, this leads to decreased overall accuracy and requires further updates (e.g., manual updates or additional maintenance report input) to address the deficiency in accuracy.

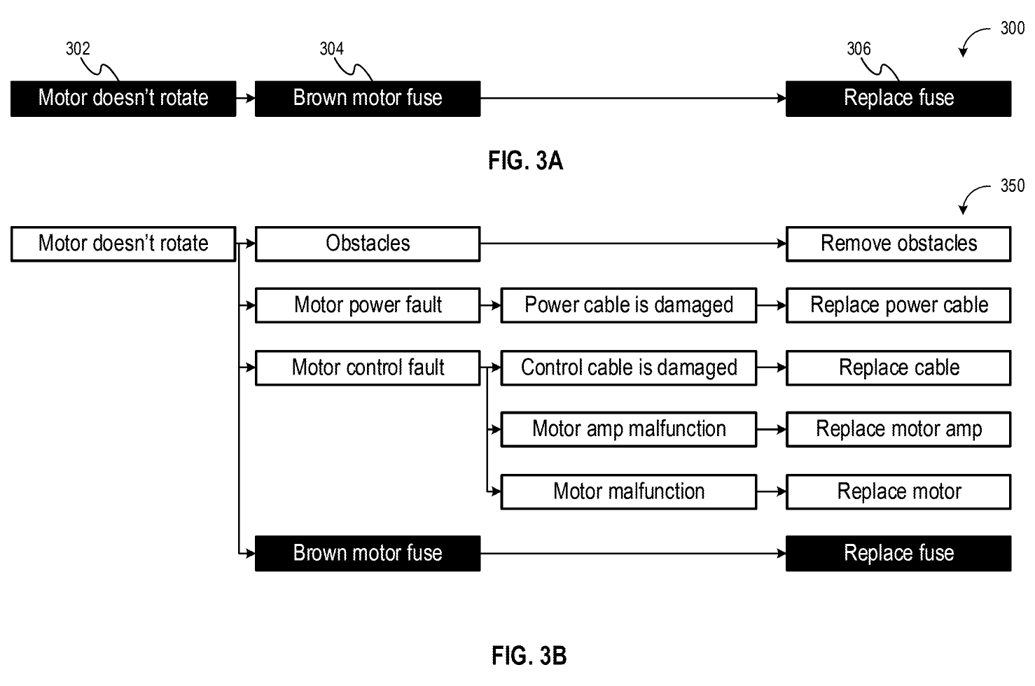

FIG. 3A illustrates a fault tree generated using a maintenance report that contains an expression error. As shown in FIG. 3A, a fault tree 300 is generated with a fault phenomenon 302 of “motor doesn’t rotate,” a fault cause 304 of “brown motor fuse,” and a recovery method 306 of “replace fuse.” Because of a typo/expression error contained in the maintenance report, “brown motor fuse” is generated as the fault cause 304 instead of “blown motor fuse.”

FIG. 3B illustrates an existing fault tree diagram 350 that has been updated with the newly generated fault tree of FIG. 3A. By merging/updating the existing fault tree diagram with the fault tree 300, the existing fault tree diagram 350 now contains a branch having “brown motor fuse” as fault cause. In order for the deficiency to be addressed/remedied, further updates from either an operator or additional maintenance report is needed, which results in wasted resource and time.

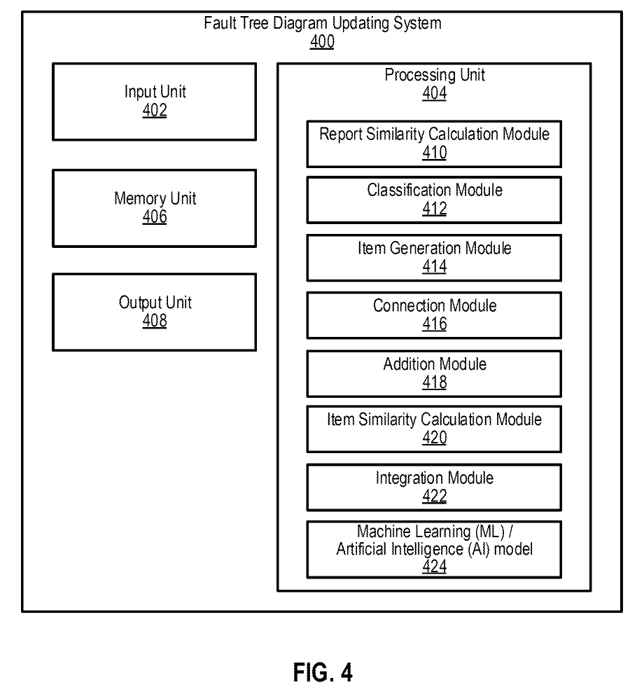

FIG. 4 illustrates an example fault tree diagram updating system 400, in accordance with an example implementation. As illustrated in FIG. 4, the fault tree diagram updating system 400 may include components such as, but not limited to, an input unit 402, a processing unit 404, a memory unit 406, an output unit 408, etc. Input unit 402 may include any device, component, sensor, or interface, physical or virtual, that can be used to provide/receive input (e.g., buttons, touch-screen interface, mouse, keyboard, a pointing/cursor control, microphone, camera, motion sensor, accelerometer, etc.). Output unit 408 may include a display, television, monitor, printer, speaker, etc., for outputting information received and generated by the fault tree diagram updating system 400.

The memory unit 406 may be any memory device such as, but not limited to, Random Access Memory (RAM), Read Only Memory (ROM), flash memory, solid-state storage, other non-volatile storage, etc., used to store instructions to be executed by the processing unit 404. The memory unit 406 further store data/information used and generated by the various components of the fault tree diagram updating system 400.

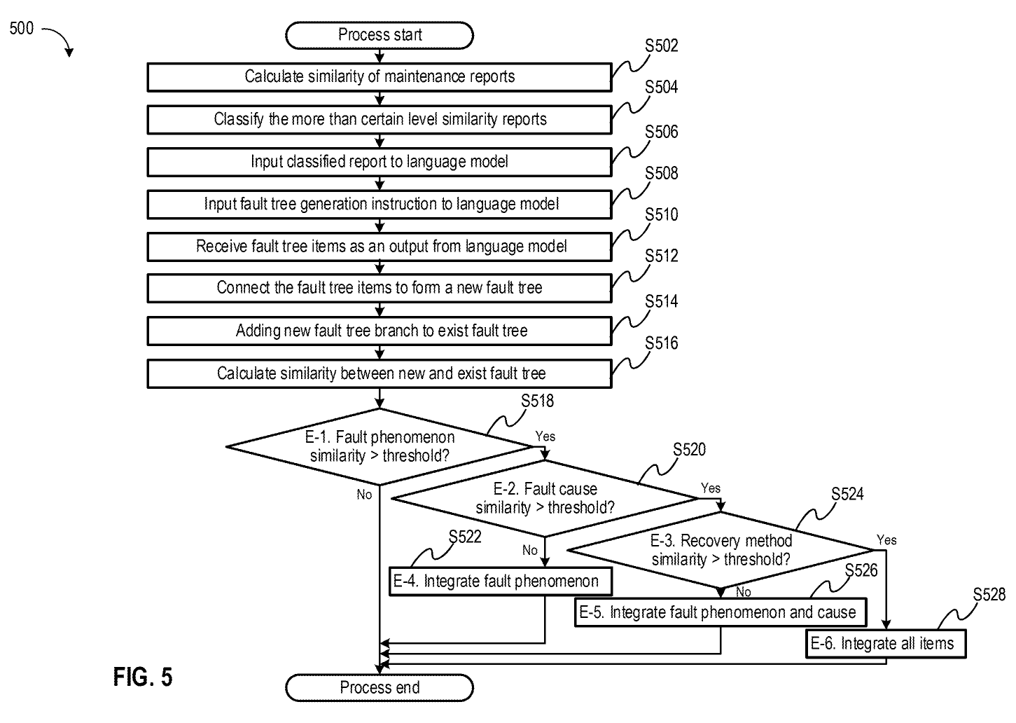

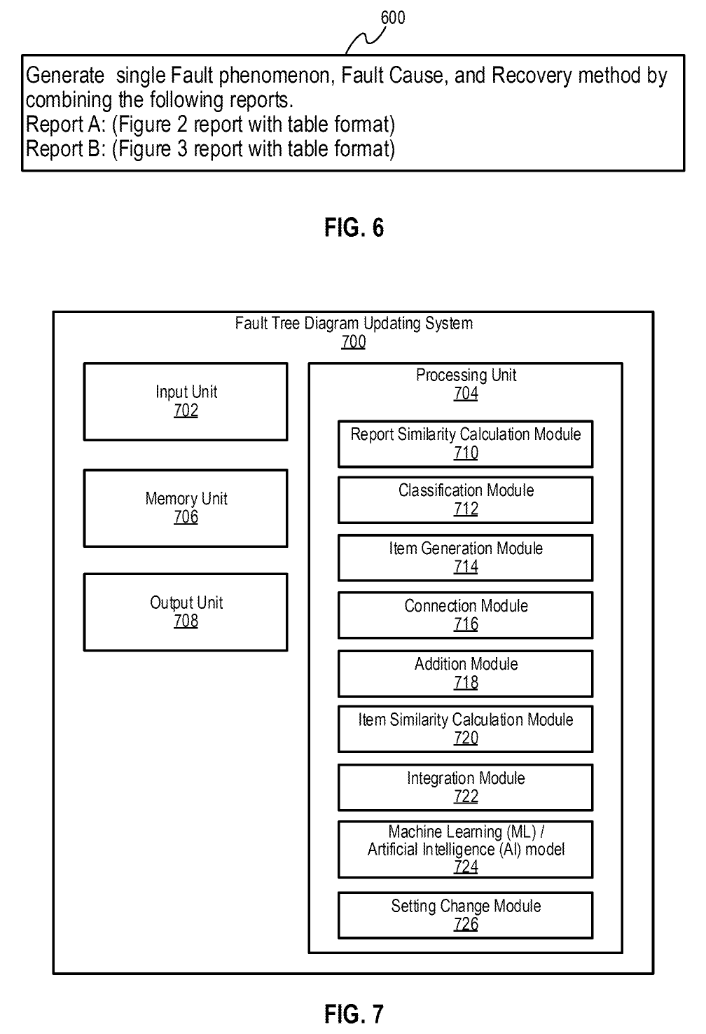

The processing unit 404 may include subcomponents such as, but not limited to, a report similarity calculation module 410, a classification module 412, an item generation module 414, a connection module 416, an addition module 418, an item similarity calculation module 420, an integration module 422, a Machine Learning (ML)/Artificial Intelligence (AI) model 424, etc., which will be described in more detail below in conjunction with FIG. 5.

FIG. 5 illustrates an example process flow 500 for updating an existing fault tree using the fault tree diagram updating system 400, in accordance with an example implementation. The process begins at step S502 where similarity between a plurality of past maintenance reports is calculated. Step S502 is performed using the report similarity calculation module 410 of FIG. 4. In some example implementations, similarity between the plurality of past maintenance reports is calculated using cosine similarity to measure similarity between maintenance reports in an inner product space. At step S504, the plurality of past maintenance reports is classified based on the calculated similarity. Step S504 is performed using the classification module 412 of FIG. 4.

The process then continues to step S506 where a subset of the plurality of past maintenance reports associated with a classification is selected as input to the ML/AI model 424 of FIG. 4. The ML/AI model 424 may include, but not limited to, one or more of convolutional neural network (CNN), recurrent neural network (RNN), deep RNN (DRNN), Q-learning network (QN), deep Q-learning network (DQN), linear regression, decision trees, K-Nearest Neighbors, etc. RNN may include long short-term memory (LSTM), large language model (LLM), etc. The ML/AI model 424 may be generated by the processing unit 404 or received from a server after the model has been trained. The ML/AI model 424 may be trained using historical maintenance report data and previously generated fault trees.

[0075]At step S508, a fault tree generation instruction is provided to the ML/AI model 424 for generating fault tree items using the subset of the plurality of past maintenance reports. The instruction is generated/issued by the item generation module 414 of FIG. 4. The ML/AI model 424 analyses and integrates the input reports based on received instructions. Fault tree items (e.g., fault phenomenon, fault cause, recovery method) are then generated as output from the ML/AI model 424 and received at step S510. The process then proceeds to step S512 where the fault tree items are connected to form a new fault tree. Step S512 is performed using the connection module 416 of FIG. 4. In some example implementations, instead of fault tree items, a complete fault tree is directly generated by the ML/AI model 424, which removes the need for the connection module 416.

[0076]At step S514, the newly generated fault tree is added to an existing fault tree diagram using the addition module 418 of FIG. 4. The process then continues to step S516 where similarity between the newly generated fault tree and an existing fault tree of the existing fault tree diagram is calculated using the item similarity calculation module 420 of FIG. 4. Similarity between fault phenomena, fault causes, and recovery methods of the newly generated fault tree and the existing fault tree is computed. Specifically, a fault phenomenon similarity is generated for each fault phenomenon identified in the newly generate fault tree, a fault cause similarity is generated for each fault cause identified in the newly generate fault tree, and a recovery method similarity is generated for each recovery method identified in the newly generated fault tree.

At step S518, the fault phenomenon similarity is compared against a first threshold/fault phenomenon threshold. If the fault phenomenon similarity exceeds the first threshold/fault phenomenon threshold, then the process continues to step S520. If the fault phenomenon similarity does not exceed the first threshold/fault phenomenon threshold, then the process comes to an end.

At step S520, the fault cause similarity is compared against a second threshold/fault cause threshold. If the fault cause similarity exceeds the second threshold/fault cause threshold, then the process continues to step S524. If the fault cause similarity does not exceed the second threshold/fault cause threshold, then the process proceeds to step S522 where only the fault phenomenon is integrated to the existing fault tree using the integration module 422 of FIG. 4.

At step S524, the recovery method similarity is compared against a third threshold/recovery method threshold. If the recovery method similarity exceeds the third threshold/recovery method threshold, then the process continues to step S528 where the fault phenomenon, the fault cause, and the recovery method are all integrated into the existing fault tree. If the recovery method similarity does not exceed the third threshold/recovery method threshold, then the process proceeds to step S526 where only the fault phenomenon and the fault cause are integrated to the existing fault tree.

FIG. 6 illustrates an example fault tree generation instruction 600, in accordance with an example implementation. The fault tree generation instruction 600 specifies the fault tree items to be generated (e.g., fault phenomenon, fault cause, recovery method), as well as the maintenance reports to be used in generating the fault tree items. As illustrated in FIG. 6, information such as report format may also be included as part of the fault tree generation instruction.

The foregoing example implementation may have various benefits and advantages. Specifically, an unconventional method and system that can automatically update fault trees based on past maintenance reports. Utilization of past maintenance reports in generating fault trees helps to reduce expression errors and expression variations, which results in increased fault tree accuracy without duplication.

FIG. 7 illustrates an alternate fault tree diagram updating system 700, in accordance with an example implementation. As illustrated in FIG. 7, the fault tree diagram updating system 700 may include components such as, but not limited to, an input unit 702, a processing unit 704, a memory unit 706, an output unit 708, etc. Input unit 702 may include any device, component, sensor, or interface, physical or virtual, that can be used to provide/receive input (e.g., buttons, touch-screen interface, mouse, keyboard, a pointing/cursor control, microphone, camera, motion sensor, accelerometer, etc.). Output unit 708 may include a display, television, monitor, printer, speaker, etc., for outputting information received and generated by the fault tree diagram updating system 700.

The memory unit 706 may be any memory device such as, but not limited to, Random Access Memory (RAM), Read Only Memory (ROM), flash memory, solid-state storage, other non-volatile storage, etc., used to store instructions to be executed by the processing unit 704. The memory unit 706 further store data/information used and generated by the various components of the fault tree diagram updating system 700.

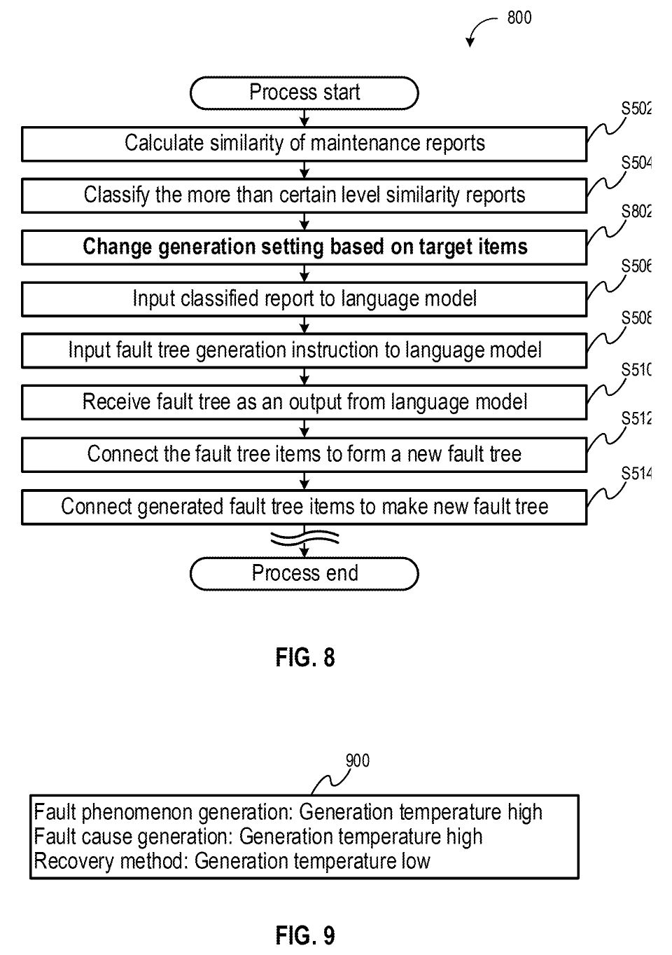

The processing unit 704 may include subcomponents such as, but not limited to, a report similarity calculation module 710, a classification module 712, an item generation module 714, a connection module 716, an addition module 718, an item similarity calculation module 720, an integration module 722, a Machine Learning (ML)/Artificial Intelligence (AI) model 724, a setting change module 726, etc., which will be described in more detail below in conjunction with FIG. 8.

FIG. 8 illustrates an alternate process flow 800 for updating an existing fault tree using the fault tree diagram updating system 700, in accordance with an example implementation. The process flow 800 is similar to process flow 500 (steps S502-S528), with the exception of the addition of step S802. The report similarity calculation module 710 corresponds to the report similarity calculation module 410 of FIG. 4. The classification module 712 corresponds to the classification module 412 of FIG. 4. The item generation module 714 corresponds to the item generation module 414 of FIG. 4. The connection module 716 corresponds to the connection module 416 of FIG. 4. The addition module 718 corresponds to addition module 418 of FIG. 4. The item similarity calculation module 720 corresponds to the item similarity calculation module 420 of FIG. 4. The integration module 722 corresponds to the integration module 422 of FIG. 4. The ML/AI model 724 corresponds to the ML/AI model 424 of FIG. 4.

The process begins at step S502 where similarity between a plurality of past maintenance reports is calculated. In some example implementations, similarity between the plurality of past maintenance reports is calculated using cosine similarity to measure similarity between maintenance reports in an inner product space. At step S504, the plurality of past maintenance reports is classified based on the calculated similarity.

On completion of step S504, generation setting is changed/modified for each target item of the fault tree that is to be generated at step S802. Step S802 is performed using the setting change module 726 of FIG. 7, which receives instructions for changing/modifying settings for items to be generated. For example, when generating items required for the new fault tree using the ML/AI model 724, the settings are changed according to the items to be generated. When selecting the next word in conjunction with large language model, the setting may be changed to select the word with the highest probability, or to select a word based on probabilities (e.g., higher random probability, etc.).

The setting that selects the highest probability has a generation temperature of zero degrees (low), and the degree of random selection can be increased by increasing the generation temperature. Here, it is important to know that the characteristics of fault tree items vary from one to the next. Specifically, the characteristic of information accuracy differs for items required for generating the fault tree. Among the items of fault phenomenon, fault cause, and recovery method, fault phenomenon and fault cause are directly recognized and defined by the report creator. On the other hand, the recovery method is described based on the work that was performed and recovery that was achieved. In other words, fault phenomenon and fault cause may be less accurate than recovery method due to the report creator's recognition bias. By modifying the generation temperature of items to be created, this allows items to be generated from past maintenance reports based on selected generation temperatures.

FIG. 9 illustrates an example generation setting instruction 900, in accordance with an example implementation. As illustrated in FIG. 9, the generation temperatures for generating fault phenomenon and fault cause may be set to high to allow words with high random probability to be selected and considered. On the other hand, the generation temperature for generating recovery method may be set to low since such items tend to be more accurate (less susceptible by recognition bias of report creator).

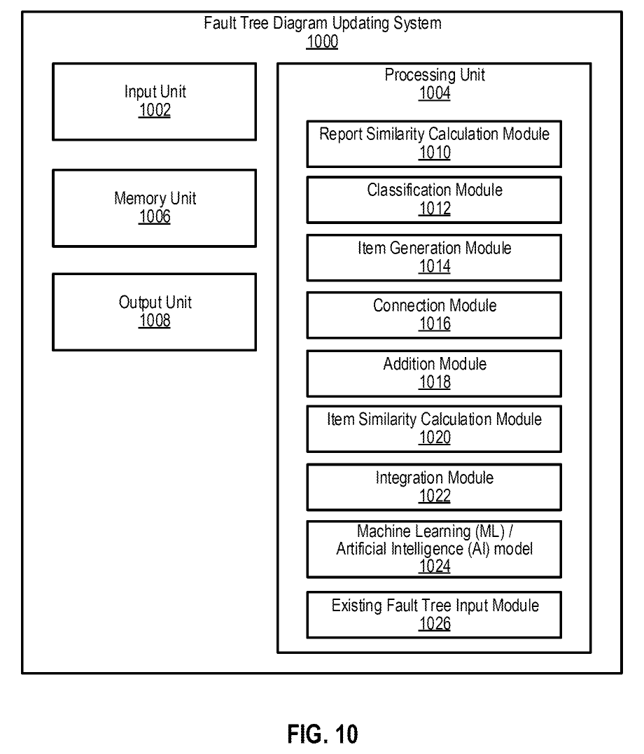

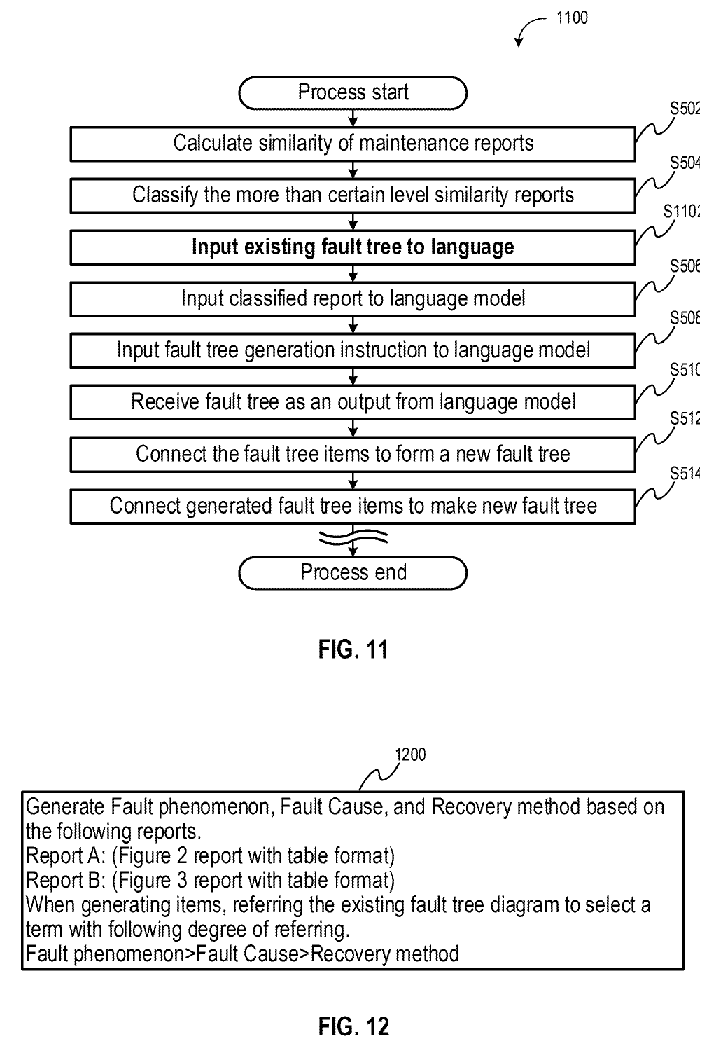

FIG. 10 illustrates an alternate fault tree diagram updating system 1000, in accordance with an example implementation. As illustrated in FIG. 10, the fault tree diagram updating system 1000 may include components such as, but not limited to, an input unit 1002, a processing unit 1004, a memory unit 1006, an output unit 1008, etc. Input unit 1002 may include any device, component, sensor, or interface, physical or virtual, that can be used to provide/receive input (e.g., buttons, touch-screen interface, mouse, keyboard, a pointing/cursor control, microphone, camera, motion sensor, accelerometer, etc.). Output unit 1008 may include a display, television, monitor, printer, speaker, etc., for outputting information received and generated by the fault tree diagram updating system 1000.

The memory unit 1006 may be any memory device such as, but not limited to, Random Access Memory (RAM), Read Only Memory (ROM), flash memory, solid-state storage, other non-volatile storage, etc., used to store instructions to be executed by the processing unit 1004. The memory unit 1006 further stores data/information used and generated by the various components of the fault tree diagram updating system 1000.

The processing unit 1004 may include subcomponents such as, but not limited to, a report similarity calculation module 1010, a classification module 1012, an item generation module 1014, a connection module 1016, an addition module 1018, an item similarity calculation module 1020, an integration module 1022, a Machine Learning (ML)/Artificial Intelligence (AI) model 1024, an existing fault tree input module 1026, etc., which will be described in more detail below in conjunction with FIG. 11.

FIG. 11 illustrates an alternate process flow 1100 for updating an existing fault tree using the fault tree diagram updating system 1000, in accordance with an example implementation. The process flow 1100 is similar to process flow 500 (steps S502-S528), with the exception of the addition of step S1102. The report similarity calculation module 1710 corresponds to the report similarity calculation module 410 of FIG. 4. The classification module 1012 corresponds to the classification module 1012 of FIG. 4. The item generation module 1014 corresponds to the item generation module 414 of FIG. 4. The connection module 1016 corresponds to the connection module 416 of FIG. 4. The addition module 1018 corresponds to addition module 418 of FIG. 4. The item similarity calculation module 1020 corresponds to the item similarity calculation module 420 of FIG. 4. The integration module 1022 corresponds to the integration module 422 of FIG. 4. The ML/AI model 1024 corresponds to the ML/AI model 424 of FIG. 4.

The process begins at step S502 where similarity between a plurality of past maintenance reports is calculated. In some example implementations, similarity between the plurality of past maintenance reports is calculated using cosine similarity to measure similarity between maintenance reports in an inner product space. At step S504, the plurality of past maintenance reports is classified based on the calculated similarity.

On completion of step S504, an existing fault tree is input into the ML/AI model 1024 using the existing fault tree input module 1026 at step S1102. Specifically, the existing fault tree is also input into the ML/AI model 1024 when generating the fault tree items for the new fault tree, and each fault tree item is generated by referring to the existing fault tree using a generation directive.

FIG. 12 illustrates an example generative directive 1200, in accordance with an example implementation. In the case of fault phenomena and causes, there is a risk that the same phenomenon or cause may be expressed differently depending on the report creator's level of knowledge/experience, along with recognition bias. As illustrated in FIG. 12, since the accuracy of fault phenomena, which are the initial observation results, differs from that of fault causes, the reference degree may be set to the order of fault phenomena > fault causes > recovery methods (descending order). Through utilization of the existing fault tree in generating the fault tree items, this helps suppress occurrences of notation variation and compensates for difference in accuracy.

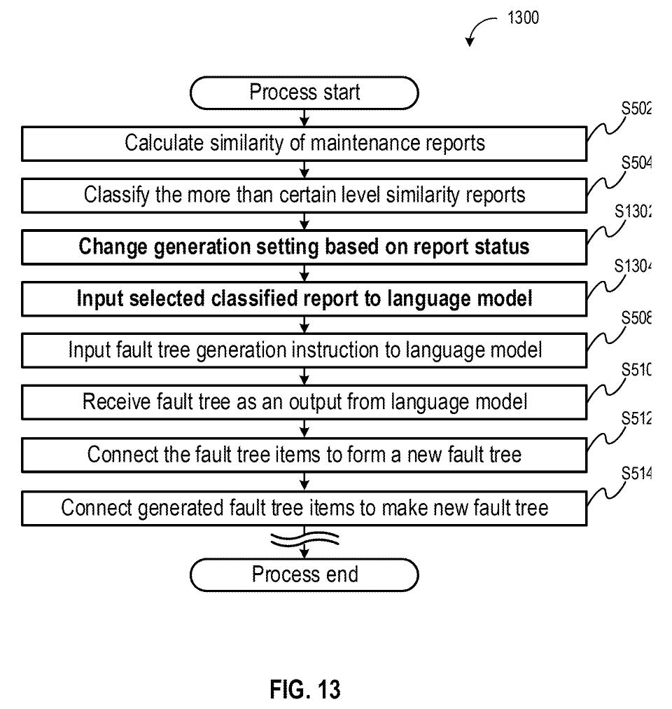

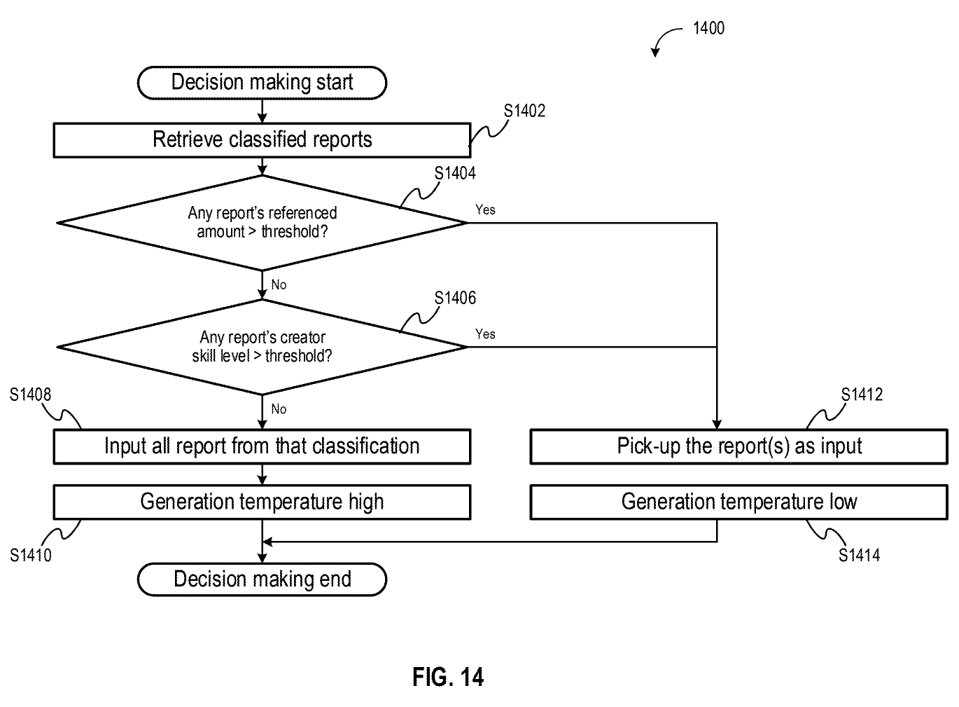

FIG. 13 illustrates an alternate process flow 1300 for updating an existing fault tree, in accordance with an example implementation. The process flow 1300 is similar to process flow 500 (steps S502-S504 and S508-S528), with the exception of the addition of steps S1302 and S1304. The process begins at step S502 where similarity between a plurality of past maintenance reports is calculated. In some example implementations, similarity between the plurality of past maintenance reports is calculated using cosine similarity to measure similarity between maintenance reports in an inner product space. At step S504, the plurality of past maintenance reports is classified based on the calculated similarity.

On completion of step S504, generation setting is changed/modified for each target item of the fault tree that is to be generated based on qualities of the past maintenance reports at step S1302.

FIG. 14 illustrates an example process flow 1400 for performing step S1302 of FIG. 13, in accordance with an example implementation. The process begins at step S1402 where classified past maintenance reports are retrieved for a classification. A determination is then made at step S1404 for each of the classified past maintenance report to see if there is any report with a referenced amount that exceeds a first threshold/reference threshold.

If the answer is “no” at step S1404, a determination is then made at step S1406 to see if there is any report in which the report creator’s skill level satisfies a second threshold/skill threshold from reports that failed to meet the first threshold/reference hold. The skill level of the report creator may be evaluated based on one or more of report quantity, professional qualifications, skill sets, experience, knowledge, etc.

For the reference threshold and the skill threshold being determined as not satisfied for all past maintenance reports in the classification, grouping all past maintenance reports as input to the ML/AI model is done at step S1408. At step S1410, the generation temperature for generating the fault tree items is automatically set to high (e.g., a preset temperature value).

For the reference threshold or the skill threshold being determined as satisfied for one or more past maintenance reports, grouping the one or more past maintenance reports as input to the ML/AI model is done at step S1412. At step S1414, the generation temperature for generating the fault tree items is automatically set to low (e.g., a preset temperature value). On completion of S1410 or S1414, the process then continues to step S1304 of FIG. 13 where the grouped maintenance reports are input to the ML/AI model.

The foregoing example implementation may have various benefits and advantages. Specifically, by selecting and referencing only high-quality reports (based on referenced amount and skill level of report creator) and modifying generation setting based on filtered reports, this allows fault tree items to be created from past maintenance reports that have been vetted, which helps increase accuracy of the created fault tree.

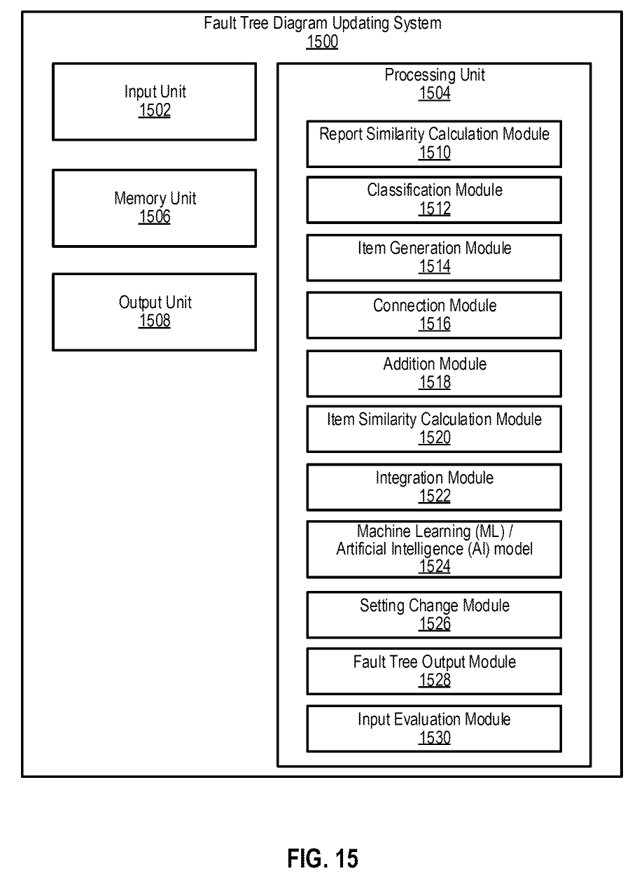

FIG. 15 illustrates an alternate fault tree diagram updating system 1500, in accordance with an example implementation. As illustrated in FIG. 15, the fault tree diagram updating system 1500 may include components such as, but not limited to, an input unit 1502, a processing unit 1504, a memory unit 1506, an output unit 1508, etc. Input unit 1502 may include any device, component, sensor, or interface, physical or virtual, that can be used to provide/receive input (e.g., buttons, touch-screen interface, mouse, keyboard, a pointing/cursor control, microphone, camera, motion sensor, accelerometer, etc.). Output unit 1508 may include a display, television, monitor, printer, speaker, etc., for outputting information received and generated by the fault tree diagram updating system 1500.

The memory unit 1506 may be any memory device such as, but not limited to, Random Access Memory (RAM), Read Only Memory (ROM), flash memory, solid-state storage, other non-volatile storage, etc., used to store instructions to be executed by the processing unit 1504. The memory unit 1506 further stores data/information used and generated by the various components of the fault tree diagram updating system 1500.

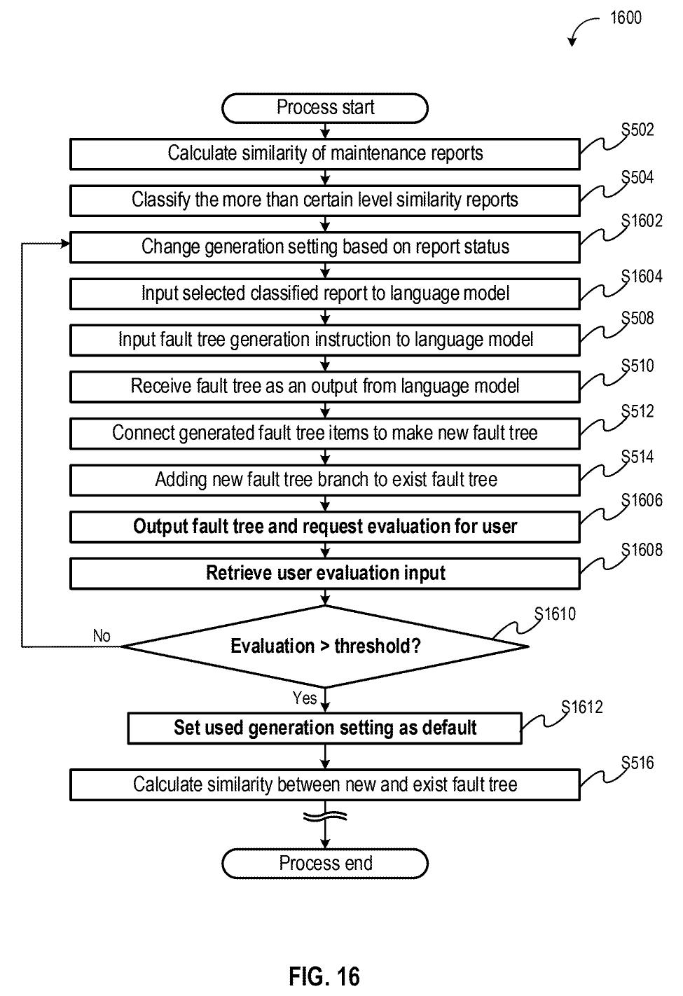

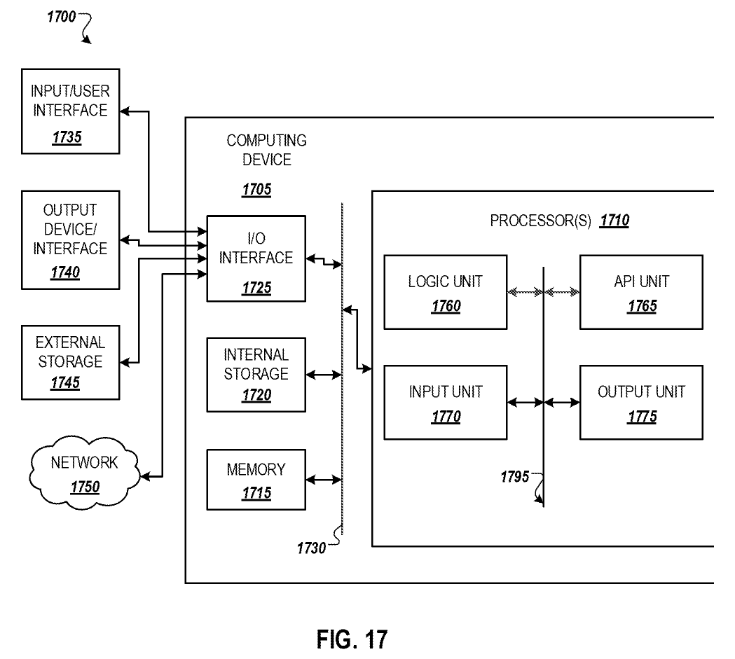

The processing unit 1504 may include subcomponents such as, but not limited to, a report similarity calculation module 1510, a classification module 1512, an item generation module 1514, a connection module 1516, an addition module 1518, an item similarity calculation module 1520, an integration module 1522, a Machine Learning (ML)/Artificial Intelligence (AI) model 1524, a setting change module 1526, a fault tree output unit 1528, an input evaluation module 1530, etc., which will be described in more detail below in conjunction with FIG. 16.

FIG. 16 illustrates an alternate process flow 1600 for updating an existing fault tree using the fault tree diagram updating system 1500, in accordance with an example implementation. The process flow 1600 is similar to process flow 500 (steps S502-S504 and S508-S528), with the exception of the addition of steps S1602-S1612. The report similarity calculation module 1510 corresponds to the report similarity calculation module 410 of FIG. 4. The classification module 1512 corresponds to the classification module 412 of FIG. 4. The item generation module 1514 corresponds to the item generation module 414 of FIG. 4. The connection module 1516 corresponds to the connection module 416 of FIG. 4. The addition module 1518 corresponds to addition module 418 of FIG. 4. The item similarity calculation module 1520 corresponds to the item similarity calculation module 420 of FIG. 4. The integration module 1522 corresponds to the integration module 422 of FIG. 4. The ML/AI model 1524 corresponds to the ML/AI model 424 of FIG. 4.

The process begins at step S502 where similarity between a plurality of past maintenance reports is calculated. In some example implementations, similarity between the plurality of past maintenance reports is calculated using cosine similarity to measure similarity between maintenance reports in an inner product space. At step S504, the plurality of past maintenance reports is classified based on the calculated similarity.

On completion of step S504, generation setting is changed/modified for each target item of the fault tree that is to be generated based on qualities of the past maintenance reports at step S1602. Past maintenance reports associated with a classification are grouped based on (i) referenced amount; and (ii) report creator’s skill level during step S1602. The process then continues to step S1604 where the grouped maintenance reports are input to the ML/AI model 1524. Steps S1602 and S1604 are similar to steps S1302 and S1304 of FIG. 13. The ML/AI model 1524 may include, but not limited to, one or more of convolutional neural network (CNN), recurrent neural network (RNN), deep RNN (DRNN), Q-learning network (QN), deep Q-learning network (DQN), linear regression, decision trees, K-Nearest Neighbors, etc. RNN may include long short-term memory (LSTM), large language model (LLM), etc.

At step S508, a fault tree generation instruction is provided to the ML/AI model 1524 for generating fault tree items using the grouped maintenance reports. The instruction is generated/issued by the item generation module 1414 of FIG. 14. The ML/AI model 1424 analyses and integrates the input reports based on received instructions. Fault tree items (e.g., fault phenomenon, fault cause, recovery method) are then generated as output from the ML/AI model 1524 and received at step S510. The process then proceeds to step S512 where the fault tree items are connected to form a new fault tree. In some example implementations, instead of fault tree items, a complete fault tree is directly generated by the ML/AI model 1524, which removes the need for the connection module 1516.

At step S514, the newly generated fault tree is added to an existing fault tree diagram using the addition module 1518 of FIG. 15. The process then continues to step S1606 where the fault tree diagram is output to a user for evaluation by the fault tree output unit 1528. An evaluation score of the fault tree diagram is then received from the user at step S1608 by the input evaluation module 1530. A determination is then made as to whether the evaluation score of the fault tree diagram exceeds an evaluation threshold at step S1610 by comparing the evaluation score against the evaluation threshold at the input evaluation module 1530.

For the evaluation score being determined to satisfy the evaluation threshold, the fault tree generation instruction is then set as default instruction at step S1612. For the evaluation score being determined as not satisfying the evaluation threshold, modifying, by the processor, the process then returns to step S1602 where the fault tree generation instruction is further modified and fault tree generation is reperformed.

The foregoing example implementation may have various benefits and advantages, such as allowing tacit human knowledge that cannot be fully quantified to be characterized and incorporated, which helps to further optimize fault tree accuracy. When the evaluation result is equal to or greater than a predetermined value, the adjusted setting may be reused in subsequent iterations to reduce wasted resource (e.g., computation resource) and time.

FIG. 17 illustrates an example computing environment with an example computer device suitable for use in some example implementations. Computing device 1705 in computing environment 1700 can include one or more processing units, cores, or processors 1710, memory 1715 (e.g., RAM, ROM, and/or the like), internal storage 1720 (e.g., magnetic, optical, solid-state storage, and/or organic), and/or IO interface 1725, any of which can be coupled on a communication mechanism or bus 1730 for communicating information or embedded in the computing device 1705. IO interface 1725 is also configured to receive images from cameras or provide images to projectors or displays, depending on the desired implementation.

Computing device 1705 can be communicatively coupled to input/user interface 1735 and output device/interface 1740. Either one or both of the input/user interface 1735 and output device/interface 1740 can be a wired or wireless interface and can be detachable. Input/user interface 1735 may include any device, component, sensor, or interface, physical or virtual, that can be used to provide input (e.g., buttons, touch-screen interface, keyboard, a pointing/cursor control, microphone, camera, braille, motion sensor, accelerometer, optical reader, and/or the like). Output device/interface 1740 may include a display, television, monitor, printer, speaker, braille, or the like. In some example implementations, input/user interface 1735 and output device/interface 1740 can be embedded with or physically coupled to the computing device 1705. In other example implementations, other computer devices may function as or provide the functions of input/user interface 1735 and output device/interface 1740 for a computing device 1705.

Examples of computing device 1705 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computing device 1705 can be communicatively coupled (e.g., via IO interface 1725) to external storage 1745 and network 1750 for communicating with any number of networked components, devices, and systems, including one or more computer devices of the same or different configuration. Computing device 1705 or any connected computer device can be functioning as, providing services of, or referred to as a server, client, thin server, general machine, special-purpose machine, or another label.

IO interface 1725 can include but is not limited to, wired and/or wireless interfaces using any communication or IO protocols or standards (e.g., Ethernet, 802.11x, Universal System Bus, WiMax, modem, a cellular network protocol, and the like) for communicating information to and/or from at least all the connected components, devices, and network in computing environment 1700. Network 1750 can be any network or combination of networks (e.g., the Internet, local area network, wide area network, a telephonic network, a cellular network, satellite network, and the like).

Computing device 1705 can use and/or communicate using computer-usable or computer readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computing device 1705 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 1710 can execute under any operating system (OS) (not shown), in a native or virtual environment. One or more applications can be deployed that include logic unit 1760, application programming interface (API) unit 1765, input unit 1770, output unit 1775, and inter-unit communication mechanism 1795 for the different units to communicate with each other, with the OS, and with other applications (not shown). The described units and elements can be varied in design, function, configuration, or implementation and are not limited to the descriptions provided. Processor(s) 1710 can be in the form of hardware processors such as central processing units (CPUs) or in a combination of hardware and software units.

In some example implementations, when information or an execution instruction is received by API unit 1765, it may be communicated to one or more other units (e.g., logic unit 1760, input unit 1770, output unit 1775). In some instances, logic unit 1760 may be configured to control the information flow among the units and direct the services provided by API unit 1765, the input unit 1770, the output unit 1775, in some example implementations described above. For example, the flow of one or more processes or implementations may be controlled by logic unit 1760 alone or in conjunction with API unit 1765. The input unit 1770 may be configured to obtain input for the calculations described in the example implementations, and the output unit 1775 may be configured to provide an output based on the calculations described in example implementations.

Processor(s) 1710 can be configured to calculate similarity between a plurality of past maintenance reports as shown in FIGS. 4 to 5. The processor(s) 1710 may also be configured to classify the plurality of past maintenance reports based on the similarity as shown in FIGS. 4 to 5. The processor(s) 1710 may also be configured to select a subset of the plurality of past maintenance reports associated with a classification as input to an Artificial Intelligence (AI) model as shown in FIGS. 4 to 5. The processor(s) 1710 may also be configured to provide a fault tree generation instruction to the AI model for generating a fault tree using the subset of the plurality of past maintenance reports as shown in FIGS. 4 to 5. The processor(s) 1710 may also be configured to receive the fault tree as output from the AI model as shown in FIGS. 4 to 5.

[0124]The processor(s) 1710 may also be configured to add the fault tree to a fault tree diagram that contains an existing fault tree as shown in FIGS. 4 to 5. The processor(s) 1710 may also be configured to update the existing fault tree with the fault tree by calculating similarities between the fault tree and the existing fault tree as shown in FIGS. 4 to 5.

The processor(s) 1710 may also be configured to calculate a fault phenomenon similarity between a fault phenomenon of the fault tree and the existing fault tree as shown in FIGS. 4 to 5. The processor(s) 1710 may also be configured to, for the fault phenomenon similarity being determined to satisfy a first threshold, integrate the fault phenomenon into the existing fault tree, and calculate a fault cause similarity between a fault cause of the fault tree and the existing fault tree, the fault cause is associated with the fault phenomenon as shown in FIGS. 4 to 5. The processor(s) 1710 may also be configured to, for the fault cause similarity being determined to satisfy a second threshold, integrate the fault cause into the existing fault tree, and calculate a recovery method similarity between a recovery method of the fault tree and the existing fault tree, the recovery method is associated with the fault cause as shown in FIGS. 4 to 5. The processor(s) 1710 may also be configured to, for the recovery method similarity being determined to satisfy a third threshold, integrate the recovery method into the existing fault tree as shown in FIGS. 4 to 5.

The processor(s) 1710 may also be configured to retrieve a first set of past maintenance reports associated with the classification, the first set of past maintenance reports comprises all past maintenance reports that are associated with the classification as shown in FIGS. 13 to 14. The processor(s) 1710 may also be configured to determine, for each of the first set of past maintenance reports, (i) whether a report reference frequency satisfies a reference threshold; and (ii) whether skill level of a report creator satisfies a skill threshold as shown in FIGS. 13 to 14.

The processor(s) 1710 may also be configured to, for the reference threshold or the skill threshold being determined as satisfied for one or more of the first set of past maintenance reports, set the one or more of the first set of past maintenance reports as the subset of the plurality of past maintenance reports as shown in FIGS. 13 to 14. The processor(s) 1710 may also be configured to, for the reference threshold and the skill threshold being determined as not satisfied for all of the first set of past maintenance reports, set the first set of past maintenance reports as the subset of the plurality of past maintenance reports as shown in FIGS. 13 to 14.

The processor(s) 1710 may also be configured to, for the reference threshold or the skill threshold being determined as satisfied for the one or more of the first set of past maintenance reports, set the temperature setting for generating the fault phenomenon, the temperature setting for generating the fault cause, and the temperature setting for generating the recovery method to a first temperature level as shown in FIGS. 13 to 14. The processor(s) 1710 may also be configured to, for the reference threshold and the skill threshold being determined as not satisfied for all of the first set of past maintenance reports, set the temperature setting for generating the fault phenomenon, the temperature setting for generating the fault cause, and the temperature setting for generating the recovery method to a second temperature level, wherein the first temperature level is lower than the second temperature level as shown in FIGS. 13 to 14.

The processor(s) 1710 may also be configured to add the fault tree to a fault tree diagram that contains an existing fault tree as shown in FIGS. 15 to 16. The processor(s) 1710 may also be configured to output the fault tree diagram to a user for evaluation as shown in FIGS. 15 to 16. The processor(s) 1710 may also be configured to receive an evaluation score of the fault tree diagram from the user as shown in FIGS. 15 to 16. The processor(s) 1710 may also be configured to compare the evaluation score against an evaluation threshold as shown in FIGS. 15 to 16. The processor(s) 1710 may also be configured to, for the evaluation score being determined to satisfy the evaluation threshold, set the fault tree generation instruction as default instruction as shown in FIGS. 15 to 16. The processor(s) 1710 may also be configured to, for the evaluation score being determined to not satisfy the evaluation threshold, modify the fault tree generation instruction and reperforming fault tree generation as shown in FIGS. 15 to 16.

The processor(s) 1710 may also be configured to provide an existing fault tree to the AI model, wherein the AI model generates the fault tree by referring to the existing fault tree to generate items in the fault tree as shown in FIGS. 10 to 12.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system’s registers and memories into other data similarly represented as physical quantities within the computer system’s memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer readable storage medium or a computer readable signal medium. A computer readable storage medium may involve tangible mediums such as, but not limited to, optical disks, magnetic disks, read-only memories, random access memories, solid-state devices, and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A fault tree generation and update method, the method comprising:
calculating, by a processor, similarity between a plurality of past maintenance reports;
classifying, by the processor, the plurality of past maintenance reports based on the similarity;
selecting, by the processor, a subset of the plurality of past maintenance reports associated with a classification as input to an Artificial Intelligence (AI) model;
providing, by the processor, a fault tree generation instruction to the AI model for generating a fault tree using the subset of the plurality of past maintenance reports; and
receiving, by the processor, the fault tree as output from the AI model.

2. The method of claim 1, wherein the AI model is a large language model.

3. The method of claim 1, further comprising:
adding, by the processor, the fault tree to a fault tree diagram that contains an existing fault tree; and
updating, by the processor, the existing fault tree with the fault tree by calculating similarities between the fault tree and the existing fault tree.

4. The method of claim 3, wherein the processor is configured to update the existing fault tree by:
calculating a fault phenomenon similarity between a fault phenomenon of the fault tree and the existing fault tree;
for the fault phenomenon similarity being determined to satisfy a first threshold, integrating the fault phenomenon into the existing fault tree, and calculating a fault cause similarity between a fault cause of the fault tree and the existing fault tree, the fault cause is associated with the fault phenomenon;
for the fault cause similarity being determined to satisfy a second threshold, integrating the fault cause into the existing fault tree, and calculating a recovery method similarity between a recovery method of the fault tree and the existing fault tree, the recovery method is associated with the fault cause; and
for the recovery method similarity being determined to satisfy a third threshold, integrating the recovery method into the existing fault tree.

5. The method of claim 1, wherein the fault tree generation instruction comprises one or more of a fault phenomenon generation setting instruction, a fault cause generation setting instruction, or a recovery method generation setting instruction.

6. The method of claim 5,
wherein the fault phenomenon generation setting instruction comprises a temperature setting for generating a fault phenomenon;
wherein the fault cause generation setting instruction comprises a temperature setting for generating a fault cause; and
wherein the recovery method generation setting instruction comprises a temperature setting for generating a recovery method.

7. The method of claim 6, wherein the selecting the subset of the plurality of past maintenance reports comprises:
retrieving, by the processor, a first set of past maintenance reports associated with the classification, the first set of past maintenance reports comprises all past maintenance reports that are associated with the classification;
determining, by the processor for each of the first set of past maintenance reports, (i) whether a report reference frequency satisfies a reference threshold; and (ii) whether skill level of a report creator satisfies a skill threshold;
for the reference threshold or the skill threshold being determined as satisfied for one or more of the first set of past maintenance reports, setting, by the processor, the one or more of the first set of past maintenance reports as the subset of the plurality of past maintenance reports; and
for the reference threshold and the skill threshold being determined as not satisfied for all of the first set of past maintenance reports, setting, by the processor, the first set of past maintenance reports as the subset of the plurality of past maintenance reports.

8. The method of claim 7, further comprising:
for the reference threshold or the skill threshold being determined as satisfied for the one or more of the first set of past maintenance reports, setting, by the processor, the temperature setting for generating the fault phenomenon, the temperature setting for generating the fault cause, and the temperature setting for generating the recovery method to a first temperature level; and
for the reference threshold and the skill threshold being determined as not satisfied for all of the first set of past maintenance reports, setting, by the processor, the temperature setting for generating the fault phenomenon, the temperature setting for generating the fault cause, and the temperature setting for generating the recovery method to a second temperature level,
wherein the first temperature level is lower than the second temperature level.

9. The method of claim 1, further comprising:
adding, by the processor, the fault tree to a fault tree diagram that contains an existing fault tree;
outputting, by the processor, the fault tree diagram to a user for evaluation;
receiving, by the processor, an evaluation score of the fault tree diagram from the user;
comparing, by the processor, the evaluation score against an evaluation threshold;
for the evaluation score being determined to satisfy the evaluation threshold, setting, by the processor, the fault tree generation instruction as default instruction; and
for the evaluation score being determined to not satisfy the evaluation threshold, modifying, by the processor, the fault tree generation instruction and reperforming fault tree generation.

10. The method of claim 1, further comprising:
providing, by the processor, an existing fault tree to the AI model;
wherein the AI model generates the fault tree by referring to the existing fault tree to generate items in the fault tree.

11. The method of claim 10,
wherein the items comprise a fault phenomenon, a fault cause, and a recovery method;
wherein the fault tree generation instruction comprises a first reference degree, a second reference degree, and a third reference degree for referencing the existing fault tree in generating the fault phenomenon, the fault cause, and the recovery method respectively; and
wherein the third reference degree, the second reference degree, and the first reference degree are in an ascending order.

12. A system for performing fault tree generation, the system comprising:
a data storage; and
a processor in communication with the data storage, wherein the processor is configured to:
calculate similarity between a plurality of past maintenance reports stored in the data storage;
classify the plurality of past maintenance reports based on the similarity;
select a subset of the plurality of past maintenance reports associated with a classification as input to an Artificial Intelligence (AI) model;
provide a fault tree generation instruction to the AI model for generating a fault tree using the subset of the plurality of past maintenance reports; and
receive the fault tree as output from the AI model and storing the fault tree in the data storage.

13. The system of claim 12, wherein the processor is further configured to:
add the fault tree to a fault tree diagram that contains an existing fault tree; and
update the existing fault tree with the fault tree by calculating similarities between the fault tree and the existing fault tree.

14. The system of claim 13, wherein the processor is configured to update the existing fault tree by:
calculating a fault phenomenon similarity between a fault phenomenon of the fault tree and the existing fault tree;
for the fault phenomenon similarity being determined to satisfy a first threshold, integrating the fault phenomenon into the existing fault tree, and calculating a fault cause similarity between a fault cause of the fault tree and the existing fault tree, the fault cause is associated with the fault phenomenon;
for the fault cause similarity being determined to satisfy a second threshold, integrating the fault cause into the existing fault tree, and calculating a recovery method similarity between a recovery method of the fault tree and the existing fault tree, the recovery method is associated with the fault cause; and
for the recovery method similarity being determined to satisfy a third threshold, integrating the recovery method into the existing fault tree.

15. The system of claim 12, wherein the fault tree generation instruction comprises one or more of a fault phenomenon generation setting instruction, a fault cause generation setting instruction, or a recovery method generation setting instruction.

16. The system of claim 15,
wherein the fault phenomenon generation setting instruction comprises a temperature setting for generating a fault phenomenon;
wherein the fault cause generation setting instruction comprises a temperature setting for generating a fault cause; and
wherein the recovery method generation setting instruction comprises a temperature setting for generating a recovery method.

17. The system of claim 16, wherein the processor is configured to select the subset of the plurality of past maintenance reports by:
retrieving a first set of past maintenance reports associated with the classification, the first set of past maintenance reports comprises all past maintenance reports that are associated with the classification;
determining, for each of the first set of past maintenance reports, (i) whether a report reference frequency satisfies a reference threshold; and (ii) whether skill level of a report creator satisfies a skill threshold;
for the reference threshold or the skill threshold being determined as satisfied for one or more of the first set of past maintenance reports, setting the one or more of the first set of past maintenance reports as the subset of the plurality of past maintenance reports; and
for the reference threshold and the skill threshold being determined as not satisfied for all of the first set of past maintenance reports, setting the first set of past maintenance reports as the subset of the plurality of past maintenance reports.

18. The system of claim 17, wherein the processor is further configured to:
for the reference threshold or the skill threshold being determined as satisfied for the one or more of the first set of past maintenance reports, set the temperature setting for generating the fault phenomenon, the temperature setting for generating the fault cause, and the temperature setting for generating the recovery method to a first temperature level; and
for the reference threshold and the skill threshold being determined as not satisfied for all of the first set of past maintenance reports, set the temperature setting for generating the fault phenomenon, the temperature setting for generating the fault cause, and the temperature setting for generating the recovery method to a second temperature level,
wherein the first temperature level is lower than the second temperature level.

19. The system of claim 12, wherein the processor is further configured to:
add the fault tree to a fault tree diagram that contains an existing fault tree;
output the fault tree diagram to a user for evaluation;
receive an evaluation score of the fault tree diagram from the user;
compare the evaluation score against an evaluation threshold;
for the evaluation score being determined to satisfy the evaluation threshold, set the fault tree generation instruction as default instruction; and
for the evaluation score being determined to not satisfy the evaluation threshold, modify the fault tree generation instruction and reperforming fault tree generation.

20. The system of claim 12, wherein the processor is further configured to:
provide an existing fault tree to the AI model;
wherein the AI model generates the fault tree by referring to the existing fault tree to generate items in the fault tree,
wherein the items comprise a fault phenomenon, a fault cause, and a recovery method,
wherein the fault tree generation instruction comprises a first reference degree, a second reference degree, and a third reference degree for referencing the existing fault tree in generating the fault phenomenon, the fault cause, and the recovery method respectively,
wherein the third reference degree, the second reference degree, and the first reference degree are in an ascending order.
